(19) United States
(12) Patent Application Publication
(10) Pub. No.: US 2006/0062151 A1
(43) Pub. Date: Mar. 23, 2006

(54) Method and device for transmitting data in a packet-based transmission network, and a correspondingly configured network element

(75) Inventor: Gunnar Hagen, Unterhaching (DE)

Correspondence Address: Harold C. Moore;Maginot, Moore & Beck, Bank One Center/Tower, 111 Monument Circle, Suite 3000, Indianapolis, IN, 46204, US

(73) Assignee: Infineon Technologies AG, Munchen (DE)

(21) Appl. No.: 11/223,808

(22) Filed: Sep. 9, 2005

(30) Foreign Application Priority Data
Sep. 9, 2004 (DE) 10 2004 043 683.5

(51) Int. Cl. H04J 1/16

(52) U.S. Cl. 370/235

(57) ABSTRACT

The invention relates to a method and a device for transmitting data in a packet-based transmission network so that a throughput of useful data is kept below a threshold value in that, in particular, pseudo-packets, which do not contain any useful information, are fed into the transmission network. The quality of voice services (for example “Voice over IP”) is thereby impaired as desired. A network element, in particular a DSLAM, which is configured for carrying out the method or comprises the device, is also provided.

### BACKGROUND

The invention relates to a method for transmitting data in a packet-based transmission network, to a corresponding device and to a network element, in particular a DSLAM, in which the device is used.

For cell or packet-based data traffic, there have long been technical approaches to ensure absolute, or at least relative, qualities of services or transmission parameters (such as, for example, Delay, Jitter, etc.). Within these approaches, specific classes (for example “Constant Bit Rate”, in the case of ATM, or “Expedited Forwarding”, in the case of IP), for which absolute or relative transmission guarantees may then be ensured, are provided.

In the past, for various reasons, no absolute resource reservation strategies (for example via broadband signalling protocols), extending over the entire communication path, have been able to establish themselves in practical application for broadband packet-switched services. Instead, a situation has increasingly arisen in which a relative service priorisation, in combination with a sufficient basic broadband provision (via a totality of possible users), has proven sufficient to use services, which are sensitive, inter alia, with respect to transmission parameters, on the network layer (including Layer 3) in a connectionless manner via the Internet, the quality on the application layer being nevertheless sufficient.

For network operators, what are known as interactive voice services are of central economic interest, as these are a substantial source of revenue. In the past, these interactive voice services have been supported primarily by time slot-based transmission methods (using narrowband switching equipment). This is an earlier method which established operators, in view of the advent of alternative transmission processes, are now calling for to be written off unexpectedly prematurely.

The established network operators are thus confronted with an economic conflict: on the one hand, there is an economic incentive to develop data networks of increasingly high quality, for example to ensure additional revenue from pure data transmission services and also to remain a general service provider. On the other hand, this gives rise to technical conditions under which revenue from existing voice transmission services is “cannibalised”, and this is undesirable for the established network operators.

For the upstream industry (Network Equipment Providers), the situation is different, as this industry is divided into two camps, which are largely independent of each other: on the one hand, there are suppliers of typical data equipment (for example Cisco), which have never produced narrowband switching equipment. On the other hand, there are long-established suppliers of telecommunications equipment (for example Siemens), whose initial attempt to enter the data market was unsuccessful. The data equipment supplier industry, which has profited from the migration, is therefore nevertheless able to provide equipment of increasingly high quality for carrying out QoS-dependent services. However, as a result of the technical possibilities, the above-described economic conflict continues to intensify for the established operators.

### SUMMARY

One advantage of the present invention is to allow the established operators to develop data networks of increasingly high quality, while at the same time slowing down, if not entirely avoiding, the resultant erosion or revenue from existing voice transmission services.

The present invention provides a method for transmitting data in a packet-based transmission network, the throughput of useful data being kept below a threshold value.

As a result of the fact that the throughput of the useful data is kept below the threshold value, it may be ensured, by correspondingly adjusting the threshold value, that a transmission quality of the useful data is never above a specific threshold value. It may thus be ensured in an advantageous manner that an absolute or relative transmission guarantee is not adhered to or cannot be adhered to.

The throughput of useful data for which a maximum permissible time delay is defined is, in particular, kept below a threshold value, the threshold value being selected such that a throughput below this threshold value inevitably results in an infringement of the maximum permissible time delay.

Time-critical useful data, such as are used, for example, in “Voice over IP”, are thus delayed (“jittered”) in a sufficiently significant manner that either a jitter, without a subsequent shaping stage, or the delay (“Transfer-Delay”), after any shaping stage for compensating the jitter, for competitive or in any way sufficient voice intelligibility, is exceeded in phases.

According to the invention, the throughput of the useful data may be kept below the threshold value in that artificial traffic, in particular pseudo-packets, is fed into the transmission network as a function of the current throughput of the useful data. The pseudo-packets do not contain any useful information.

As a result of the feeding of the pseudo-packets, these pseudo-packets compete with packets containing useful load, as a result of which these packets containing useful load are impeded, thus in turn causing the transmission quality of these packets containing useful load to be reduced. As the pseudo-packets are fed in as a function of the current throughput of the useful data, the pseudo-packets are fed in only if the throughput of the useful data is, for example, above a predetermined threshold value. Conversely, this means that no pseudo-packets are fed in if the packets containing useful load are already sufficiently impeded for other reasons (for example, because an important connection node in the transmission network has failed or because a correspondingly large amount of useful load has to be transmitted).

In particular, the pseudo-packets within a node of the transmission network are fed in and removed from this node once they have sufficiently impeded packets containing useful load, so the throughput of the useful data remains below the threshold value.

As no pseudo-packets leave the node, the pseudo-packets occur only at predetermined points, i.e. in predetermined nodes, in the transmission network, as a result of which it advantageously becomes more difficult, in comparison to a method in which the pseudo-packets occur on connection lines between the nodes of the transmission network, to discover the fact that the pseudo-packets are fed into the transmission network in the first place.

According to the invention, the pseudo-packets may be generated in that they are copied from packets comprising useful data and marked as pseudo-packets.

Apart from their marking, the pseudo-packets therefore correspond to, and may hardly be distinguished from, packets comprising useful data. Precisely because the packets comprising useful data differ substantially with respect to their length, the copying of packets comprising useful data is advantageous if it is to be concealed that pseudo-packets are fed into the transmission network, as the artificially fed-in pseudo-packets therefore do not differ, with respect to their length, from naturally occurring packets comprising useful data.

The pseudo-packets of a specific packet type may, in particular, be fed into the transmission network only if a throughput of packets of this specific packet type is above a threshold value determined for this packet type. The specific packet type may, in particular, designate packets containing time-critical useful data, the threshold value determined for this packet type being in this case adjusted such that a throughput of packets of this packet type below this threshold value results in an infringement of the maximum permissible time delay that is defined for the time-critical useful data.

It is thus advantageously possible to impede only packets of one packet type or to force a throughput of packets of this packet type below the threshold value determined for packets of this packet type. It is thus advantageously possible, for example, to impede only time-critical packets by means of the pseudo-packets, while leaving other packets, which transmit time-uncritical data, almost unimpeded.

According to the invention, the pseudo-packets may be fed in only at specific times, which are determined at random.

As a result of the fact that pseudo-packets are fed into the transmission network only at times selected at random, packets comprising useful data are also impeded only at these times selected at random. It is thus even harder to demonstrate whether packets comprising useful data are deliberately impeded, since it is, for example, impossible externally to simulate (from outside the node) a situation that inevitably always results in an impeding of useful data.

According to the invention, the throughput of the useful data is below the threshold value if, in particular, one or more of the following conditions are fulfilled:
a packet throughput, which is defined by a number of packets comprising useful data that pass per unit of time through a node of the transmission network, is below a first threshold value.
an average delay, which a packet comprising useful data experiences on passing through the node of the transmission network, is above a second threshold value.
a maximum delay, which occurs at a quantity of packets comprising useful data that pass per unit of time through the node of the transmission network, is above a third threshold value.

Since, according to the invention, the throughput of packets comprising useful data is kept below the threshold value, in particular, by means of the feeding of pseudo-packets, pseudo-packets are fed into the transmission network or packets comprising useful data impeded, as a result of the above-described, somewhat more complex definition of the threshold value, if one or more of the above-described conditions are met. If, for example, it is defined that the throughput of the useful data is below the threshold value only if the average delay is above the second threshold value, the packets comprising useful data are, according to the invention, impeded, in particular by means of the feeding of pseudo-packets, such that the average delay is above the second threshold value even if the packet throughput is, for example, significantly below the first threshold value, even without impeding. According to the invention, the packets comprising useful data may thus be impeded per unit of time, irrespective of the number of the packets comprising useful data, such that the average delay of the packets comprising useful data is above the second threshold value. A protocol that presupposes that the packets comprising useful data at their centre do not require longer than a predetermined period for a specific distance within the transmission network may thus, according to the invention, not be implemented if the method according to the invention is used. Corresponding considerations apply to the condition with respect to the maximum delay. In other words, even a protocol that presupposes that the packets comprising useful data do not exceed the maximum delay per unit of time may not be applied if the method according to the invention is correspondingly in use. According to the invention, the use of an interactive voice service is thus not possible if the method according to the invention is active.

The present invention also provides a device for transmitting data in a packet-based transmission network. This device is configured such that, as a function of a throughput of useful data, it feeds pseudo-packets into the transmission network such that the pseudo-packets prevent forwarding of the useful data.

The device comprises, in particular, a throughput measuring unit and a pseudo-packet generator, the throughput measuring unit determining a throughput of packets through the device and the pseudo-packet generator generating and feeding pseudo-packets if it is advised by the throughput measuring unit that the throughput is above a threshold value. The pseudo-packet generator generates and feeds the pseudo-packets such that the throughput of the packets comprising useful data is forced below the threshold value.

Since a node of the transmission network according to the prior art usually comprises a throughput measuring unit, only the pseudo-packet generator, in an advantageous manner, has additionally to be introduced in a suitable manner into the node and correspondingly coupled to the throughput measuring unit.

Moreover, the device may also comprise a classifier, which is configured such that it allocates a packet type to each packet that reaches the device. The throughput measuring unit may thus determine the throughput of the packets for each packet type, as a result of which the device may in turn detect if the throughput of a specific packet type is above a threshold value determined for this packet type. In this case, the pseudo-packet generator may generate and feed pseudo-packets of this packet type such that the throughput of the packets of this specific packet type is forced below the threshold value determined for this packet type.

Since a node according to the prior art generally also has a classifier, the device has merely to provide a corresponding coupling of the throughput measuring unit and the classifier to the pseudo-packet generator. As a result of the fact that the device forces only the throughput of specific packet types below the respective threshold value determined for this packet type, the device is able to impede only the packets of these specific packet types, whereas the packets of other packet types are able to pass through the device almost unimpeded.

The device may also comprise a filter, which filters out the pseudo-packets before the pseudo-packets leave the node.

Precisely for reasons of cost, it is in turn also advantageous that the node according to the prior art generally comprises a filter, so this filter has merely to be adjusted such that it also detects and filters out pseudo-packets.

The present invention also provides a network element of a packet-based transmission network, which element is configured for carrying out the above-described method according to the invention and/or is configured such that it comprises an above-described device according to the invention. The network element is, in particular, an access network element, usually a DSLAM, which provides access to the transmission network to at least one subscriber.

A packet-based transmission network consists of nodes or network elements and links or connection lines, which connect the network elements. The network elements forward packets, which have reached them via connected connection lines, to connection lines, which are also connected to them. Precisely the access network elements, in particular DSLAMs, form an excellent access point, from the point of view of network development strategy, into the transmission network and have generally been technically mastered by the traditional suppliers of conventional telecommunications equipment. A DSLAM (“Digital Subscriber Line Access Multiplexer”) is generally taken to be a device comprising at least one port for lines leading to subscribers. One port is connected to a suitable modem (usually a DSL modem) on the subscriber side.

Since the “Quality of Service” property is a property that is related to a total respective transmission path and has to be ensured over each node or point in this transmission path, it can, conversely, also be influenced in a crucially disadvantageous manner at an individual node. Since a transmission path between two subscribers necessarily extends via at least one access network element, it is sufficient, according to the invention, for each access network element to comprise one device according to the invention in order to be able to prevent the transmission of packets on any desired transmission path.

The present invention is suitable, in particular, for impeding time-critical useful data in a packet-based transmission network such that, for example, a telephone conversation conducted via the transmission network exhibits a desired poor voice intelligibility. The invention is not, of course, limited to this preferred field of application, but may also be used, for example, to check, directly and independently of an external traffic situation, a desired configuration of a transmission network.

### BRIEF DESCRIPTION OF THE DRAWINGS

The present invention will be described below in greater detail, using a preferred embodiment and with reference to the accompanying drawings, in which:

FIG. 1 shows a device according to the invention for transmitting data in a packet-based transmission network; and

FIG. 2 shows a DSLAM according to the invention.

### DESCRIPTION

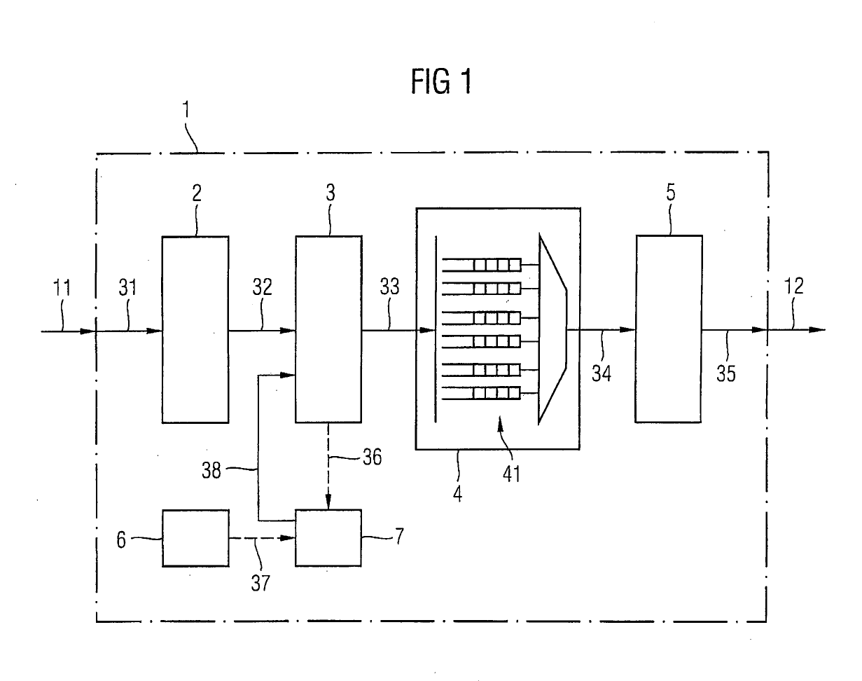

A device according to the invention illustrated in FIG. 1 for transmitting data in a packet-based transmission network comprises a throughput measuring unit 2, a classifier 3, a sequence control system 4, a filter 5, a signal transmitter 6 and a pseudo-packet generator 7, which will be described below in greater detail.

The classifier 2 allocates, on the basis of specific properties, each packet 11 entering the device 1 to a specific packet type, as a result of which each packet is in turn associated with what is known as a flow, properties of a head of the respective packet generally being evaluated above all. The classifier 2 thus substantially provides a grouping function, which assists uniform treatment of packets sharing specific properties. For this purpose, the classifier 2 applies rules to fields of the packet and provides a corresponding result, generally as an item of meta data based on the packet. Using this item of meta data or the information provided thereby, the following processing steps may be carried out.

The throughput measuring unit 3 ascertains specific flow properties and is able to evaluate said properties against a filed profile. The throughput measuring unit 3 can, for example, ascertain when limits, which designate a specific throughput of packets, are exceeded or undershot. The throughput measuring unit 3 may then provide this information to subsequent elaboration units or processing steps, similarly to the classifier 2, explicitly as an item of meta data. In the case of the present embodiment, the sequence control system 4 is what is known as a “Weighted Fair Queuing Scheduler”, which uses a generally known sequence control process that ensures, in phases of the congestion of a path, that individual FIFO queues 41 outlined schematically in FIG. 1 experience at least a specific operating rate, as a fixed proportion of a maximum total rate possible at a point denoted by reference numeral 34. If no packets are ordered in individual queues 41, a bandwidth, which is otherwise provided as an operating rate for this queue, is divided fairly, i.e. proportionally, over other queues 41, without places (what are known as “Working-Slots”) becoming lost in the process. A procedure of this type is also known as “Work-conserving Behaviour”. On the other hand, this procedure ensures that, at times of congestion, there may not be any operating rates above it for individual queues.

The pseudo-packet generator 7 generates artificial packet traffic in that it generates pseudo-packets, labels them as such and multiplexes them into a packet flow of packets comprising useful data.

The signal transmitter 6 supplies, in a random sequence for a specific period, an active signal 37, which the pseudo-packet generator 7 also evaluates in order to decide whether artificially generated packet traffic should be multiplexed into the packet flow of the packets comprising useful data.

The filter 5 rejects packets that exhibit specific, explicitly labelled properties. The filter 5 rejects, in particular, pseudo-packets generated artificially by the pseudo-packet generator 7.

The mode of operation of the device 1 will be described below.

Useful data traffic enters the device 1 at point 31. The useful data traffic flows onward via the throughput measuring unit 2 and is labelled as useful data traffic at the output 32 of the throughput measuring unit 2. Individual packets may also be allocated to specific queues 41 of the sequence control system 4 via the meta data associated with the packets. “Voice over IP” traffic may, for example, be identified unambiguously by using specific protocols (for example RTP or UDP) in conjunction with specific port regions.

In certain load situations, the throughput measuring unit 3 ascertains that a specific, previously fixed load limit has been undershot and signals this to the pseudo-packet generator 7 via a first signal 36. If the pseudo-packet generator 7 receives a second signal, in addition to the first signal 36, from the signal transmitter 6, the pseudo-packet generator 7 provides at its output 38 pseudo-packets, the statistical properties of which correspond to the packets comprising useful data occurring at the input 31 of the classifier 2. This is brought about in that, in the event of time intervals of a high useful data load, packets are copied from the throughout measuring unit 3 to the pseudo-packet generator 7, in order then at a later point in time to be fed in, labelled as pseudo-packets.

The throughput measuring unit multiplexes the pseudo-packets into the stream of the useful data and evaluates a characteristic of a sum from the useful data stream and a sum of the pseudo-packets with respect to load limits. The first signal 36 is set to “inactive” only if a total packet stream, as a result of a sufficient feeding-in of pseudo-packets, again exhibits a characteristic above a specific limit.

The sequence control system 4 operates its various queues in a conventional manner. However, as pseudo-packets are now also contained, distributed over the queues, a situation of excess bandwidth, as a result of which the useful data traffic is actually delayed (jittered), only occurs to a limited extent, as the pseudo-packets, for their part, also claim places in the queues.

The pseudo-packets are subsequently filtered out in the filter 5, so they do not leave the device 1 via an output 12 of the device 1.

The above-described device may be used, inter alia, in conjunction with purposeful packet classification such that voice services, for example, exhibit only a reduced quality. In practical terms, a repercussion thereby intended may not be distinguished from effects that may occur as a consequence of natural congestion as a result of overload situations, which are generally short-term. An application of the device 1 may be demonstrated only with considerable production costs and with authorisation to have physical measuring points provided even in regions of foreign network height.

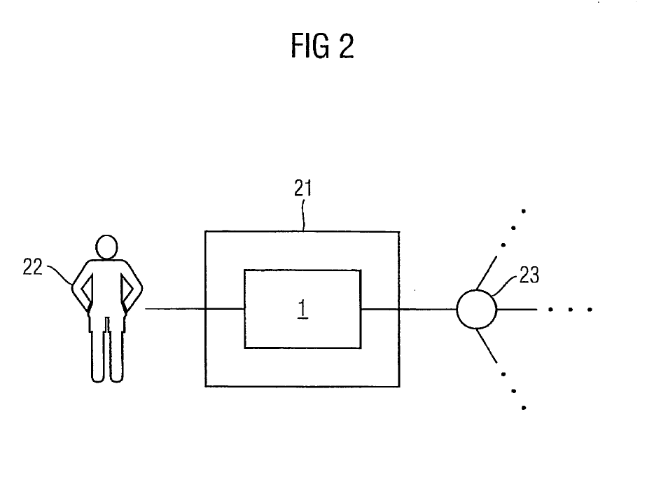

FIG. 2 shows a DSLAM 21, which comprises the above-described device 1. The DSLAM 21 connects a subscriber 22 to a node 23, which is located further within the transmission network. As each transmission path that the subscriber 22 constructs passes via the DSLAM 21, each transmission path may accordingly be disturbed by the DSLAM 21. A telephone call conducted by the subscriber 22 and passing via the DSLAM 21 may thus, for example, be disturbed by the device 1 within the DSLAM 21 at any time and to any degree.

1-25. (canceled)

26. A method for transmitting data comprising:
transmitting data in a packet-based transmission network; and
keeping a throughput of useful data below a threshold value.

27. The method according to claim 26, wherein a maximum permissible time delay is defined for the throughput of useful data; and
further comprising selecting the threshold value such that a throughput below the threshold value results in an infringement of the maximum permissible time delay.

28. The method according to claim 26, wherein artificial traffic containing no useful information is fed into the transmission network to keep the throughput of useful data below the threshold value.

29. The method according to claim 28, wherein the artificial traffic comprises pseudo-packets.

30. The method according to claim 29, wherein the step of keeping the throughput of useful data below the threshold value comprises:
feeding the pseudo-packets within a node of the transmission network; and
removing the pseudo-packets within the node when pseudo-packets have impeded packets containing useful data.

31. The method according to claim 29, wherein the pseudo-packets are copies of packets comprising useful data and are marked as pseudo-packets.

32. The method according to claim 29, further comprising:
determining a threshold value for a throughput of packets of a specific packet type; and
feeding pseudo-packets of the specific packet type into the transmission network when the throughput of the specific packet type is a above the threshold value for the specific packet type.

33. The method according to claim 32, wherein the specific packet type comprises packets containing time-critical useful data wherein a maximum permissible delay is defined for the packets containing time-critical useful data; and
wherein a threshold value for throughput of packets containing time-critical useful data is such that a throughput below the threshold value for throughput of packets containing time-critical useful data results in an infringement of the maximum permissible time delay.

34. The method according to claim 29, wherein the pseudo-packets are fed into the transmission network only at specific times.

35. The method according to claim 34, wherein the times are determined at random.

36. The method according to claim 26, wherein the throughput of useful data is below the threshold value when a packet throughput is below a first threshold value, the packet throughput comprising a number of packets comprising useful data that pass through a node of the transmission network per a unit of time.

37. The method according to claim 26, wherein the throughput of useful data is below the threshold value when an average delay that a packet comprising useful data experiences through a node of the transmission network is above a second threshold value.

38. The method according to claim 26, wherein the throughput of useful data is below the threshold value when a maximum delay is above a third threshold value, the maximum delay being a time that is allowed for throughput of a number of packets comprising useful data per unit of time through a node of the transmission network.

39. A device for transmitting data in a packet-based transmission network, the device comprising:
a pseudo-packet generator operable to generate pseudo-packets containing no useful information, the pseudo-packet generator being configured to feed the generated pseudo-packets into the transmission network to prevent forwarding of useful data packets.

40. The device according to claim 39, further comprising:
a throughput measuring unit configured to detect whether throughput of packets through the device is above a threshold value; and
wherein the pseudo-packet generator is configured to generate and feed pseudo-packets into the device when the throughput measuring unit has detected that the throughput of packets through the device is above the threshold value.

41. The device according to claim 40, wherein the throughput measuring unit is configured to determine that the throughput of packets is below a threshold value when a packet throughput is below a first threshold value, the packet throughput being the number of packets comprising useful data that pass through a node of the transmission network per unit of time.

42. The device according to claim 40, wherein the throughput measuring unit is configured to determine that the throughput of packets is below a threshold value when an average delay that a packet comprising useful data experiences through a node of the transmission network is above a second threshold value.

43. The device according to claim 40, wherein the throughput measuring unit is configured to determine that the throughput of packets is below a threshold value when a maximum delay is above a third threshold value, the maximum delay being a time that is allowed for throughput of a quantity of packets comprising useful data through the device.

44. The device according to claim 40, further comprising:
a classifier configured to allocate a packet type to each packet that reaches the device;
wherein the throughput measuring unit is configured to determine a throughput of packets based on the packet type, and to determine whether the throughput of the packet type is above a threshold value determined for the packet type;
wherein the pseudo-packet generator is configured to generate and feed pseudo-packets of the packet type into the network such that the throughput of the packet type is below the threshold value for the packet type.

45. The device according to claim 42, further comprising:
a sequence control system configured to control forwarding of all of the packets passing through the device based on the packet type.

46. The device according to claim 40, wherein the pseudo-packet generator is configured to generate pseudo-packets by copying packets comprising useful data passing through the device and marking the copied packets as pseudo-packets.

47. The device according to claim 40, wherein the pseudo-packet generator is configured to generate pseudo-packets only in response to a control signal.

48. The device according to claim 47, further comprising:
a signal transmitter connected to the pseudo-packet generator, wherein the signal transmitter is configured to generate the control signal.

49. The device according to claim 48, wherein the signal transmitter is configured to generate the control signal with a random duration and with random pauses during which the signal transmitter does not generate the control signal.

50. The device according to claim 39, further comprising:
a filter configured to filter out all of the pseudo-packets before the pseudo-packets leave the device.

51. A network element for providing access to a transmission network for at least one subscriber, the network element comprising:
a pseudo-packet generator operable to generate pseudo-packets containing no useful information, and feed the generated pseudo-packets into the network element to prevent forwarding of useful data packets; and
a throughput measuring unit operably configured to monitor throughput of packets through the network element and generate a control signal when the throughput of packets is above a threshold value;
wherein the pseudo-packet generator is configured to generate pseudo-packets in response to the control signal.

52. The network element according to claim 51, wherein the network element comprises a DSLAM.
